(19) United States
(12) Patent Application Publication
(10) Pub. No.: US 2005/0100342 A1
(43) Pub. Date: May 12, 2005

(54) Optical dispersion compensation system and method in optical communication system

(75) Inventor: Jung-Jae Park, Seoul (KR)

Correspondence Address: JONATHAN Y. XANG, ESQ.;LEE, HONG, DEGERMAN, KANG & SCHMADEKA P.C., 14TH FLOOR, 801 S. FIGUEROA STREET, LOS ANGELES, CA, 90017, US

(73) Assignee: LG Electronics Inc.

(21) Appl. No.: 10/987,978

(22) Filed: Nov. 12, 2004

(30) Foreign Application Priority Data
Nov. 12, 2003 (KR) 10-2003-0079821

(51) Int. Cl. H04B 10/12

(52) U.S. Cl. 398/148

(57) ABSTRACT

An optical dispersion compensation system and method in an optical communication system prevents distortion of an optical signal by removing residual dispersion. The system comprises an input port for inputting an optical signal to an optical fiber, an output port for outputting the optical signal, a plurality of optical band splitters for splitting the optical signal into a plurality of optical signals, each having a wavelength band, a plurality of band dispersion compensation optical fibers for dispersion-compensating each of the optical signals with a different amount of dispersion compensation, and converging means for converging each of the optical signals passing through each band dispersion compensation optical fiber to the output port.

### CROSS-REFERENCE TO RELATED APPLICATIONS

Pursuant to 35 U.S.C. § 119(a), this application claims the benefit of earlier filing date and right of priority to Korean Application No. 10-2003-79821, filed on Nov. 12, 2003, the contents of which is hereby incorporated by reference herein in its entirety.

### BACKGROUND OF THE INVENTION

1. Field of the Invention

The present invention relates to an optical dispersion compensation system and method in an optical communication system, and more particularly to a system and method for compensating for dispersion of wavelengths.

2. Description of the Related Art

The development of information-related technologies such as computer and communication technologies has been helped considerably by high-speed optical fiber communication technologies which can transmit and receive large volumes of information. Due to current tendencies such as high-rate transmissions of multimedia information including various types of data such as moving pictures, voice signals and character signals, bi-directional interactive communication environments, and an enormous increase in the number of subscribers, technologies for transmitting and receiving more information in the same optical transmission line without distortion are specially required.

Specifically, technologies for changing a transmission line into a broadband and dividing channels in a predetermined bandwidth are necessary. An optical fiber for use as the transmission line in an optical communication system comprises an optical waveguide containing silicon oxide as a major element. The optical fiber has wave characteristics for an optical signal of a channel having different wavelengths. According to the characteristics of the optical fiber transmission line, after the optical signal outputted from a transmitter passes through a predetermined distance of optical fiber transmission line, distortion of the optical signal must be compensated, to facilitate communication without errors.

The distortion of the optical signal signifies loss of the optical signal energy and dispersion of the optical signal. By using an optical fiber amplifier containing erbium (Er), the loss of the optical signal energy can be efficiently compensated. However, the dispersion of the optical signal is still a problem that must be solved for ultra-high speed long distance optical communication.

The dispersion of the optical signal constitutes a dispersion of an optical pulse passing through the optical fiber. In a 1550 nm band, the optical fiber approximately has a dispersion coefficient of D=17˜18 ps/nm/km.

In a Wavelength Division Multiplexing (WDM) optical transmission system, when an optical signal is transmitted over a 10 Gbps level per channel, dispersion of the optical signal must be compensated. Additionally, when a transmission speed of an optical signal is 10 Gbps, the optical signal is distorted if a transmission distance is over 60 km. Accordingly, it is difficult to transmit the optical signal over 100 km.

Referring to FIG. 1, an optical dispersion compensation system in an optical communication system of the related art comprises a dispersion compensation optical fiber 30 for compensating for dispersion of an optical signal from an input optical fiber 10, and for outputting the dispersion compensation optical signal to an output optical fiber 20. The input optical fiber 10 and the output optical fiber 20 are general optical fibers that are transmission lines.

Generally, ideal dispersion of the optical fiber has a constant value throughout the whole wavelength area. However, dispersion of the optical fiber is changed according to wavelengths with a predetermined gradient. That is, when the gradient decreases, variation amounts of dispersion according to the wavelengths are reduced.

Referring to FIGS. 1 and 2, in the WDM optical transmission system, when the optical signal passes through the input optical fiber 10 at a transmission speed over 10 Gbps (point B), a different amount of dispersion is generated in each wavelength of the optical signal. The optical signal having dispersion in each wavelength is inputted to the dispersion compensation optical fiber 30. After dispersion of the optical signal is compensated for by the dispersion compensation optical fiber 30, residual dispersion exists in each channel (each wavelength) of the optical signal due to wavelength dependency of the dispersion coefficient of the dispersion compensation optical fiber 30 (point C). For example, as shown in FIG. 2, when dispersion of λ₁˜λ_{3N} transmission wavelengths is compensated for by the dispersion compensation optical fiber 30, dispersion of λ₁ wavelength is completely compensated. However, residual dispersion d₁, d₂ and d₃ exists in λ_{N}, λ_{2N} and λ_{3N} wavelengths. In the case of a long distance transmission, the residual dispersion is linearly accumulated through a few dispersion compensation optical fibers. Although a different amount of dispersion is generated in each wavelength, the related art optical dispersion compensation system using the dispersion compensation optical fiber compensates for dispersion of all wavelengths by a predetermined length (L in FIG. 2). As a result, the related art optical dispersion compensation system cannot precisely compensate for dispersion of each wavelength, thereby increasing signal distortion.

### SUMMARY OF THE INVENTION

The present invention is directed to an optical dispersion compensation system and method in an optical communication system. The optical dispersion compensation system and method prevent distortion of an optical signal by removing residual dispersion of each wavelength band of the optical signal passing through a common dispersion compensation optical fiber, by splitting the optical signal into wavelength bands and passing the optical signals of each wavelength band through a different length of dispersion compensation optical fibers.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described herein, an optical dispersion compensation system and method is provided. In one embodiment, the system comprises an input port for inputting an optical signal to an optical fiber, an output port for outputting the optical signal, a plurality of optical band splitters for splitting the optical signal into a plurality of optical signals, each having a wavelength band, a plurality of band dispersion compensation optical fibers for dispersion-compensating each of the optical signals with a different amount of dispersion compensation, and converging means for converging each of the optical signals passing through each band dispersion compensation optical fiber to the output port.

In one exemplary embodiment, the converging means comprises a plurality of optical reflectors for respectively reflecting each of the optical signals and a plurality of optical attenuators for respectively attenuating to a predetermined level the intensities of the optical signals passing through the band dispersion compensation optical fibers.

The system further comprises an optical circulator for transmitting the optical signal from the input port to one of the plurality of optical band splitters and transmitting the optical signal from one of the plurality of optical band splitters to the output port and a common dispersion compensation optical fiber connected between the optical circulator and one of the plurality of optical band splitters for commonly compensating dispersion of all wavelengths of the optical signal, wherein the number of the plurality of optical band splitters is equal to the number of the plurality of split optical signals.

In another exemplary embodiment, the amount of dispersion compensation of the dispersion compensation optical fiber in each wavelength increases when the wavelength of the split wavelength band is long, wherein the dispersion compensation optical fiber of the wavelength band having the longest wavelength has the longest length. Furthermore, the amount of dispersion compensation of the dispersion compensation optical fiber in each wavelength decreases when the wavelength of the split wavelength band is short, wherein the dispersion compensation optical fiber of the wavelength band having the shortest wavelength has the shortest length. Also, the length of each dispersion compensation optical fiber is approximately one-half (½) of a length for completely removing residual dispersion of the optical signal from the corresponding wavelength band.

In accordance with one aspect of the invention, an optical dispersion compensation method in an optical communication system comprises splitting an optical signal into a plurality of optical signals, each having a transmission wavelength band, and removing residual dispersion by respectively passing each of the optical signals through a plurality of dispersion compensation optical fibers having different lengths.

The method further comprises commonly compensating for dispersion of all transmission wavelength bands of the optical signal by using a common dispersion compensation optical fiber, respectively attenuating to a predetermined level the intensities of the optical signals passing through the dispersion compensation optical fibers and respectively reflecting the optical signals.

In one exemplary embodiment, the dispersion compensation optical fiber of the wavelength band having the longest wavelength has the longest length and the dispersion compensation optical fiber of the wavelength band having the shortest wavelength has the shortest length, wherein the length of each dispersion compensation optical fiber is approximately one-half (½) of a length for completely removing residual dispersion of the optical signal from the corresponding wavelength band and approximately one-half (½) of the residual dispersion of each of the optical signals is removed by respectively passing through a different length of dispersion compensation optical fiber.

In another exemplary embodiment, the optical signals are attenuated to a predetermined level by passing through a respective optical attenuator, reflected by a respective optical reflector and re-pass through the respective optical attenuator and the respective dispersion compensation optical fiber, wherein the optical signal wavelength band having the longest wavelength among the optical signals of the split wavelength bands does not pass through the optical attenuator.

In accordance with another aspect of the invention, an optical dispersion compensation system in an optical communication system comprises a plurality of optical band splitters for splitting an optical signal into a plurality of optical signals, each having a wavelength band, a plurality of dispersion compensation optical fibers having different lengths for removing residual dispersion of each of the optical signals, a plurality of optical reflectors for respectively reflecting each of the optical signals, and a plurality of optical attenuators for respectively attenuating to a predetermined level the intensities of the optical signals passing through the dispersion compensation optical fibers, wherein the number of the plurality of optical band splitters is equal to the number of the plurality of split optical signals.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a schematic structure diagram illustrating an optical dispersion compensation system using a dispersion compensation optical fiber in an optical communication system of the related art.

FIG. 2 is a graph showing dispersion compensation results by the related art dispersion compensation optical fiber.

FIG. 3 is a structure diagram illustrating an optical dispersion compensation system in an optical communication system in accordance with one embodiment of the invention.

FIG. 4 is a graph showing transmission wavelengths with residual dispersions removed after being compensated for by the optical dispersion compensation system in accordance with one embodiment of the invention.

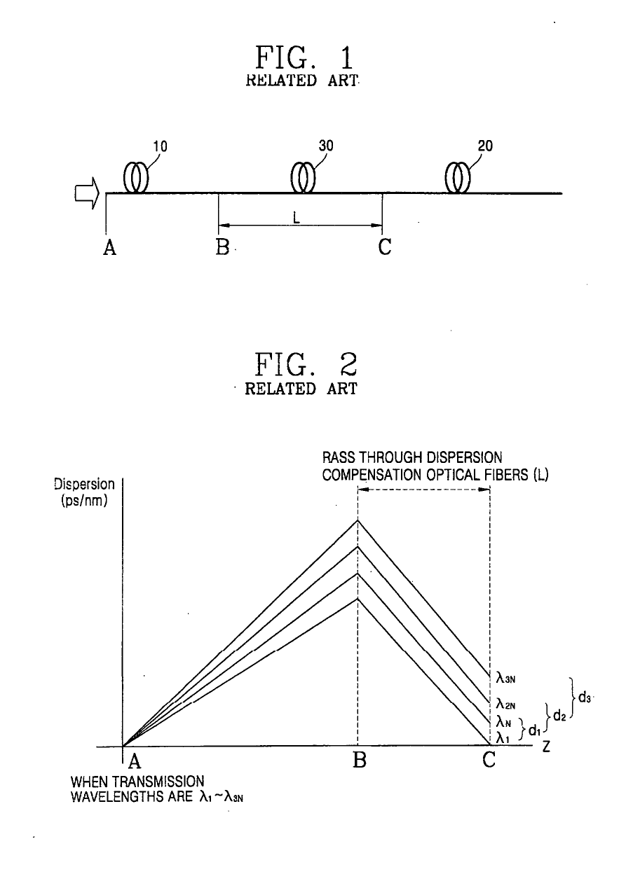

### DETAILED DESCRIPTION OF THE PREFERRED EMBODIMENTS

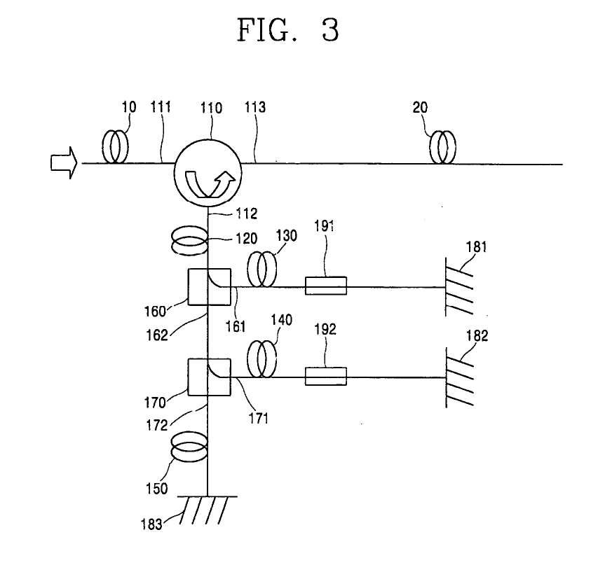

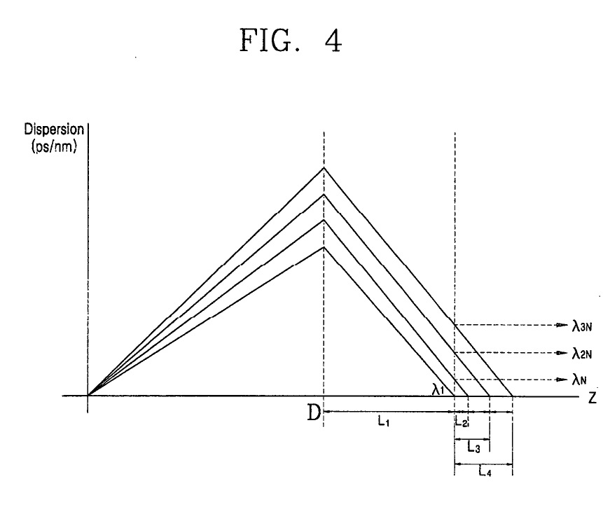

Referring to FIG. 3, an optical dispersion compensation system in an optical communication system comprises an optical circulator 110 for transmitting an optical signal inputted from an input optical fiber 10 to a first port 111 to a second port 112, and outputting an optical signal inputted to the second port 112 to an output optical fiber 20 through a third port 113. The system further comprises a common dispersion compensation optical fiber 120 for commonly compensating for dispersion of the optical signal from the second port 112 of the optical circulator 110, a plurality of optical band splitters 160, 170 for splitting the optical signal from the common dispersion compensation optical fiber 120 into wavelength bands, a plurality of band dispersion compensation optical fibers 130, 140, 150 connected respectively to output ports 161, 171, 172 of the plurality of optical band splitters 160, 170 to have a different length in each wavelength band, and a plurality of optical reflectors 181, 182, 183 for reflecting the optical signals of each wavelength band passing through each band dispersion compensation optical fiber 130, 140 and 150, respectively. The number of optical band splitters may or may not be dependent upon the number of transmission wavelength bands split from the optical signal. In a preferred embodiment, the number of optical band splitters is equal to the number of wavelength bands split, for example.

Referring to FIG. 4, a graph depicting transmission wavelengths with respective residual dispersions removed after the optical dispersion compensation system of FIG. 3 compensates dispersion of each transmission wavelength is shown. In the case where the transmission wavelengths λ₁˜λ_{3N} of the optical signal are divided into λ₁˜λ_{N}, λ_{N+1}˜λ_{2N} and λ_{2N+1}˜λ_{3N} bands and dispersion thereof is compensated, L1 is a length of a dispersion compensation optical fiber for commonly compensating for dispersion of all wavelengths λ₁˜λ_{3N} of the optical signal, L2 is a length of a dispersion compensation optical fiber for removing residual dispersion of λ₁˜λ_{N} band, L3 is a length of a dispersion compensation optical fiber for removing residual dispersion of λ_{N+1}˜λ_{2N} band, and L4 is a length of a dispersion compensation optical fiber for removing residual dispersion of λ_{2N+1}˜λ_{3N} band.

The common dispersion compensation optical fiber 120, as shown in FIG. 3, is formed to have a length corresponding to approximately one-half (½) of L1 of FIG. 4, for example. The first band dispersion compensation optical fiber 130 is formed to have a length corresponding to approximately one-half (½) of L2, for example. The second band dispersion compensation optical fiber 140 is formed to have a length corresponding to approximately one-half (½) of L3, for example. The third band dispersion compensation optical fiber 150 is formed to have a length corresponding to approximately one-half (½) of L4, for example.

The length of the first band dispersion compensation optical fiber 130 is shorter than the length of the third band dispersion compensation optical fiber 150. Thus, intensity (or strength) of the optical signal passing through the first band dispersion compensation optical fiber 130 is stronger than the intensity of the optical signal passing through the third band dispersion compensation optical fiber 150. Accordingly, when the optical signal passing through the first band dispersion compensation optical fiber 130 and the optical signal passing through the third band dispersion compensation optical fiber 150 are inputted to the common dispersion compensation optical fiber 120, different intensities of optical signals are combined. Therefore, a first optical attenuator 191 is connected between the first band dispersion compensation optical fiber 130 and the first optical reflector 181, and a second optical attenuator 192 is connected between the second band dispersion compensation optical fiber 140 and the second optical reflector 182.

The first optical attenuator 191 attenuates the optical signal λ₁˜λ_{N} as much as an attenuation amount when the optical signal λ₁˜λ_{N} passes through L4-L2 length of dispersion compensation optical fiber in FIG. 4. The second optical attenuator 192 attenuates the optical signal λ_{N+1}˜λ_{2N} as much as an attenuation amount when the optical signal λ_{N+1}˜λ_{2N} passes through L4-L3 length of dispersion compensation optical fiber in FIG. 4. As a result, the optical signals passing through the first to third band dispersion compensation optical fibers 130, 140 and 150 respectively have the same intensity.

The operation of the optical dispersion compensation system in the optical communication system in accordance with one embodiment of the invention will now be explained. When the optical signal having λ₁˜λ_{3N} transmission wavelengths reaches the first port 111 through the input optical fiber 10, as shown as D of FIG. 4, each wavelength is dispersed at a different amount.

In one embodiment, the optical circulator 110 outputs the optical signal reaching the first port 111 to the second port 112. The common dispersion compensation optical fiber 120 having approximately one-half (½) the length of L1 compensates for dispersion of the optical signal from the second port 112, for example. The first optical band splitter 160 outputs λ₁˜λ_{N} band transmission wavelength of the optical signal passing through the common dispersion compensation optical fiber 120 to the first output port 161, and outputs the other wavelengths λ_{N+1}˜λ_{2N} of the optical signal to the second output port 162. The second optical band splitter 170 outputs λ_{N+1}˜λ_{2N} band transmission wavelength of the optical signal from the second output port 162 to the second output port 171, and outputs the other wavelengths λ_{2N+1}˜λ_{3N} of the optical signal to the third output port 172.

Accordingly, the optical signal of the λ₁˜λ_{N} band transmission wavelength is dispersion-compensated through the first band dispersion compensation optical fiber 130 having approximately one-half (½) the length of L2, passes through the first optical attenuator 191, is reflected by the first optical reflector 181, and re-passes through the first optical attenuator 191, the first band dispersion compensation optical fiber 130 and the first optical band splitter 160.

In a certain embodiment, the optical signal of the λ_{N+1}˜λ_{2N} band transmission wavelength is dispersion-compensated through the second band dispersion compensation optical fiber 140 having approximately one-half (½) the length of L3, passes through the second optical attenuator 192, is reflected by the second optical reflector 182, and re-passes through the second optical attenuator 192, the second band dispersion compensation optical fiber 140 and the second optical band splitter 170. The optical signal of the λ_{2N+1}˜λ_{3N} band transmission wavelength is dispersion-compensated through the third band dispersion compensation optical fiber 150 having approximately one-half (½) the length of L4, is reflected by the third optical reflector 183, and re-passes through the third band dispersion compensation optical fiber 150 and the second optical band splitter 170.

The optical signal of the λ₁˜λ_{N} band transmission wavelength, the optical signal of the λ_{N+1}˜λ_{2N} band transmission wavelength and the optical signal of the λ_{2N+1}˜λ_{3N} band transmission wavelength that are split by the first optical band splitter 160 and the second optical band splitter 170 are dispersion-compensated by the common dispersion compensation optical fiber 120 having one-half (½) the length of L1, and outputted to the third port 113 by the optical circulator 110.

In an exemplary embodiment, the optical signal of the λ₁˜λ_{N} band transmission wavelength passes, for example, twice through the first band dispersion compensation optical fiber 130 and the common dispersion compensation optical fiber 120, thereby passing through L1+L2 length of dispersion compensation optical fiber. In addition, the optical signal of λ_{N+1}˜λ_{2N} band transmission wavelength passes, for example, twice through the second band dispersion compensation optical fiber 140 and the common dispersion compensation optical fiber 120, thereby passing through L1+L3 length of dispersion compensation optical fiber. Meanwhile, the optical signal of λ_{2N+1}˜λ_{3N} band transmission wavelength passes, for example, twice through the third band dispersion compensation optical fiber 150 and the common dispersion compensation optical fiber 120, thereby passing through L1+L4 length of dispersion compensation optical fiber.

In the optical dispersion compensation system, the optical attenuators compensate for optical attenuation differences generated when the optical signals pass through the different length of dispersion compensation optical fibers. Even if the dispersion amount of each wavelength is different, the optical dispersion compensation system removes the residual dispersion by passing the optical signals of each wavelength through the different lengths of dispersion compensation optical fibers.

As discussed earlier, in accordance with the present invention, the optical dispersion compensation system precisely compensates for dispersion of the whole transmission wavelengths of the optical signal and prevents signal distortion by varying the amount of dispersion compensation of each transmission wavelength by passing the optical signals of each wavelength through the different lengths of dispersion compensation optical fibers.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

1. An optical dispersion compensation system in an optical communication system, comprising:
an input port for inputting an optical signal to an optical fiber;
an output port for outputting the optical signal;
a plurality of optical band splitters for splitting the optical signal into a plurality of optical signals, each having a wavelength band;
a plurality of band dispersion compensation optical fibers for dispersion-compensating each of the optical signals with a different amount of dispersion compensation; and
converging means for converging each of the optical signals passing through each band dispersion compensation optical fiber to the output port.

2. The system of claim 1, wherein the converging means comprises a plurality of optical reflectors for respectively reflecting each of the optical signals.

3. The system of claim 2, wherein the converging means comprises a plurality of optical attenuators for respectively attenuating to a predetermined level the intensities of the optical signals passing through the band dispersion compensation optical fibers.

4. The system of claim 1, further comprising an optical circulator for transmitting the optical signal from the input port to one of the plurality of optical band splitters and transmitting the optical signal from one of the plurality of optical band splitters to the output port.

5. The system of claim 4, further comprising a common dispersion compensation optical fiber connected between the optical circulator and one of the plurality of optical band splitters for commonly compensating dispersion of all wavelengths of the optical signal.

6. The system of claim 1, wherein the number of the plurality of optical band splitters is equal to the number of the plurality of split optical signals.

7. The system of claim 1, wherein the amount of dispersion compensation of the dispersion compensation optical fiber in each wavelength increases when the wavelength of the split wavelength band is long.

8. The system of claim 7, wherein the dispersion compensation optical fiber of the wavelength band having the longest wavelength has the longest length.

9. The system of claim 8, wherein the amount of dispersion compensation of the dispersion compensation optical fiber in each wavelength decreases when the wavelength of the split wavelength is short.

10. The system of claim 9, wherein the dispersion compensation optical fiber of the wavelength band having the shortest wavelength has the shortest length.

11. The system of claim 10, wherein the length of each dispersion compensation optical fiber is approximately one-half (½) of a length for completely removing residual dispersion from the optical signal of the corresponding wavelength band.

12. An optical dispersion compensation method in an optical communication system, comprising:
splitting an optical signal into a plurality of optical signals, each having a transmission wavelength band; and
removing residual dispersion by respectively passing each of the optical signals through a plurality of dispersion compensation optical fibers having different lengths.

13. The method of claim 12, further comprising commonly compensating for dispersion of all transmission wavelength bands of the optical signal by using a common dispersion compensation optical fiber.

14. The method of claim 12, further comprising respectively attenuating to a predetermined level the intensities of the optical signals passing through the dispersion compensation optical fibers.

15. The method of claim 14, further comprising respectively reflecting each of the optical signals.

16. The method of claim 12, wherein the dispersion compensation optical fiber of the wavelength band having the longest wavelength has the longest length.

17. The method of claim 16, wherein the dispersion compensation optical fiber of the wavelength band having the shortest wavelength has the shortest length.

18. The method of claim 17, wherein the length of each dispersion compensation optical fiber is approximately one-half (½) of a length for completely removing residual dispersion of the optical signal from the corresponding wavelength band.

19. The method of claim 18, wherein approximately one-half (½) of the residual dispersion of each of the optical signals is removed by respectively passing through a different length of dispersion compensation optical fiber.

20. The method of claim 19, wherein the optical signals are attenuated to a predetermined level by passing through a respective optical attenuator, reflected by a respective optical reflector and re-pass through the respective optical attenuator and the respective dispersion compensation optical fiber.

21. The method of claim 20, wherein the optical signal wavelength band having the longest wavelength among the optical signals of the split wavelength bands does not pass through the optical attenuator.

22. An optical dispersion compensation system in an optical communication system, comprising:
a plurality of optical band splitters for splitting an optical signal into a plurality of optical signals, each having a wavelength band;
a plurality of dispersion compensation optical fibers having different lengths for removing residual dispersion of each of the optical signals;
a plurality of optical reflectors for respectively reflecting each of the optical signals; and
a plurality of optical attenuators for respectively attenuating to a predetermined level the intensities of the optical signals passing through the dispersion compensation optical fibers.

23. The system of claim 22, wherein the number of the plurality of optical band splitters is equal to the number of the plurality of split optical signals.
